(19) United States
(12) Patent Application Publication
(10) Pub. No.: US 2011/0202950 A1
(43) Pub. Date: Aug. 18, 2011

(54) Interactive Multimedia System and Methods

(75) Inventor: Peter STOUGAARD, Studio City, CA (US)

(73) Assignee: Moonbeach Entertainment

(21) Appl. No.: 12/705,744

(22) Filed: Feb. 15, 2010

(51) Int. Cl. H04N 7/16

(52) U.S. Cl. 725/23

(57) ABSTRACT

A system, and methods for using that system, are provided that encourage viewers to watch and listen to a variety of multimedia event presentations. The various multimedia event presentations are received by the viewers on a receiving module and are displayed on a display module. Along with the multimedia event presentations (primary in the form of broadcast shows and ancillary in the form of advertisements and commercials), the viewers are provided with one or more interactive presentations (games) and additional browsing features by means of graphics-rich overlays through which they can participate and interact. Interaction is provided for by way of user input (communications) modules connected to the receiving modules and the display modules.

### BACKGROUND OF THE INVENTION

1. Field of the Invention

The present invention relates generally to interactive audio/video or multimedia systems and methods of using such systems. The present invention relates more specifically to an interactive multimedia presentation system, as well as methods for its use, that provide for the real-time active participation of a viewer in the multimedia events being presented, the active participation operable in conjunction with advertisements and other ancillary material broadcast or streamed in conjunction with the presented event.

2. Description of the Related Art

A multimedia event presentation of any kind (which may include without limitation such presentations as; sitcoms, live soccer matches, reality shows, first-run dramas, and so on) are inevitably and almost necessarily accompanied by advertising presentation. Advertisements are by definition broadcast for the promotion of a specific product or a brand and have as their goal to encourage the sale of those products or services marketed under the brand. Advertisements can themselves be termed a type of a multimedia event presentation, although usually in a very capsulated form. Advertisements are the primary source of income for the broadcasters and the more viewers are engaged with a particular advertisement the more likely they are to purchase the products or services. Advertisers are, of course, willing to pay more for advertisements that they know will most fully engage the viewer.

It is to be understood that throughout the following discussions and descriptions references will be made to a variety of different multimedia presentation systems, typical of which are televisions and computers. It will be understood that any reference to a television or a television broadcast is meant to likewise include all other forms of multimedia event presentation. Any system that allows for the presentation of a audio/video or multimedia event in conjunction with advertising through that same medium, could be included as part of the systems and methods described. Use of televisions and television broadcasts in the following discussions and examples should not be viewed as limiting of the possible applications of the present invention.

A viewer of a multimedia event presentation is typically disinclined to watch advertisements. Continuous and/or repetitive broadcasting of advertisements hampers the continuity of the multimedia event presentation. Generally there is little connection between the event being presented and the advertisements that are interspersed throughout the presentation. There is little guarantee that what interests the viewer about the presented event will likewise interest the viewer in the advertisements periodically presented. The viewer may in fact choose to eliminate these advertisements through systems and methods known in the field. Efforts in the past to allow viewers to avoid viewing advertisements have included such systems as time shifted recording through a Digital Video Recorder (DVR) or other device that enables capturing a multimedia presentation (such as a television program or the like) to a hard disk or any other suitable digital electronic storage medium for later viewing. A special feature of certain digital electronic storage devices such as a TiVO® device is that it can record and play simultaneously. A viewer can view the recorded television program and skip or fast forward through the advertisements.

In general, a DVR is any device that enables recording of a television program in a digital format to a hard disk or any other suitable storage medium. U.S. Pat. No. 4,972,396 titled Multiple Independently Positionable Recording-Reading Head Disk System, assigned to Honeywell Inc., describes a drive-based DVR designed for home TV recording, time-slipping, and skipping advertisements. Use of such a device and others like it, may eventually hinder the financial viability of television advertising, thus defeating the lucrative purpose associated with broadcasting visual events and incorporating paid advertising to support that broadcast.

One method for preventing a viewer from skipping advertisements is to embed advertising clips over the ongoing television program, thus forcing the viewer to watch the advertisement along with the ongoing visual event. By using this method, valuable screen space is lost. Another method for forcing a viewer to watch the advertisements is to broadcast the advertisements prior to the broadcast of the visual events. For example; any streamed visual event over the Internet may be preceded by advertisements. Thus the viewer is forced to watch the advertisements whenever he wishes to watch the desired visual event via the Internet. This method may serve to only further annoy the viewer.

The broadcaster is interested in attracting viewers to be engaged by (i.e. to “watch”) all types of visual events including the advertisements. It may also be desirable, for example, to provide the viewer with additional features and information presented while viewing a visual event. Such other features and information might include such audio/visual presentations as a program schedule, player or team details (while viewing a sporting event), payment information while viewing a pay per view movie or the like. These features are generally related in some way to the multimedia event being presented so there is at least an expected interest in the material on the part of the viewer.

In the past there have been attempts to attract viewers to watch the visual events, including the advertisements and to provide various additional features, by making television interactive. Past attempts have generally presented one way interactions where the viewers are not able to actively participate in the visual event being broadcast, only in the ancillary material that is presented. An example of such one way interaction is encountered where the viewers are asked to vote for a choice of movie. The viewers vote on various choices through cellular short messaging services (SMS) or through call in telephone services. However, the viewers are generally not able to participate in addressing the ancillary presentation while the primary multimedia event is being broadcast. Systems and methods for presenting multimedia events are therefore generally incapable of drawing a viewer's attention to advertising presentations (the “ancillary presentations”) as completely as the viewer is drawn to the multimedia event presentation (the “primary presentation”). Yet to be developed, therefore, is an effective way of engaging the viewer of a primary presentation with an ancillary presentation that includes advertising material. Currently the viewer will typically choose to view one or the other (mainly because of their unrelated content) and, if the necessary technology is available, to avoid viewing the ancillary content altogether.

In light of the foregoing discussion there is a need for an interactive multimedia (audio/video) system, and methods for using such a system, where viewers can be drawn to watch advertisements that are presented along with the other multimedia events being presented. There is a need to provide an interactive presentation to the viewer in association with the ancillary presentations (the advertisements) that draws upon the established connection that the viewer already has to the primary presentation (the multimedia event being broadcast). There is a need to provide a method whereby a viewer can remain engaged with the primary and ancillary presentations and still participate with the interactive presentation that may be simultaneously offered (displayed). Further, there is a need to provide viewers more detailed and segregated menus for ease of browsing through the interactive presentation materials that allows them to remain engaged with the primary and ancillary presentation subject matters. Therefore, the need to develop an interactive system which allows active participation of the viewer in a variety of multimedia events being broadcast, and to incorporate advertising material into that broadcast, is apparent.

### SUMMARY OF THE INVENTION

According to the present invention therefore, a system and methods for using that system are provided that encourage viewers to watch and listen to a variety of multimedia event presentations. The various multimedia event presentations are received by the viewers on a receiving module and are displayed on a display module. Along with the multimedia event presentations (primary and ancillary), the viewers are provided with one or more interactive presentations (games) by means of graphics-rich overlays through which they can participate and interact. Interaction is provided for by way of user input (communications) modules connected to the receiving modules and the display modules.

An object of the present invention is therefore to provide a system and methods for encouraging viewers to watch a variety of multimedia event presentations displayed on a display means. Another object of the present invention is to encourage viewers to watch advertising ancillary presentations (commercials) which may be broadcast in between other primary multimedia event presentations.

Another object of the present invention is to provide one or more interactive presentations (games) over other multimedia event presentations (ancillary and in some instances, primary) and to provide means for viewers to actively participate in the interactive presentations. Yet another object of the present invention is to provide viewers an opportunity to win prizes while watching multimedia event presentations.

In accordance with various embodiments of the present invention, a viewer while watching a multimedia event presentation (generally an ancillary presentation such as a commercial) on a display means is provided with one or more interactive presentations (games) in the form of graphic-rich overlays guiding various interactive actions. The viewer can participate in the one or games and be awarded points or other consideration for their successful participation. The viewer is also provided with a menu bar containing detailed information regarding the ongoing multimedia event presentations on the display means.

An objective of the present invention is to maintain the engagement of the viewer with the ancillary presentations (the commercials and advertisements) when these are interspersed with the primary presentation (the broadcast event presentation). The viewer is engaged by being provided an attractive interactive overlay to the ancillary presentations, one that involves the viewer but yet does not fully distract the viewer from the content of the ancillary presentations. In this manner, the content of the advertising presented is more fully conveyed to and retained by the viewer instead of being avoided and ignored, as is currently often the case. The engagement of the viewer is a result of both the overlay format (requiring simultaneous viewing) and a carefully coordinated subject matter connection between the interactive presentation, the ancillary presentation (the commercial), and in some cases, the primary presentation (the broadcast show or event).

Specific embodiments of the invention will hereinafter be described in conjunction with the appended drawings provided to illustrate and not to limit the invention, wherein like designations denote like elements, and in which:

### BRIEF DESCRIPTION OF THE DRAWINGS

FIG. 1 is a schematic block diagram illustrating an environment in which the system of the present invention may be implemented, in accordance with the various method embodiments of the invention.

FIG. 2 is a functional block diagram illustrating a system for encouraging viewers to watch multimedia event presentations, in accordance with an embodiment of the present invention.

FIG. 3 illustrates a display module in accordance with an embodiment of the present invention showing the implementation of one of the various method embodiments of the present invention.

FIG. 4 is a flow chart showing the method steps involved in an illustrative method for encouraging viewers to watch multimedia event presentations, in accordance with an embodiment of the present invention.

### DETAILED DESCRIPTION OF THE PREFERRED EMBODIMENTS

Various embodiments of the present invention provide methods and a system for encouraging viewers to watch multimedia event presentations. These event presentations can be audio/video broadcasts through a variety of technologies from satellite broadcasting systems to streamed audio/video via the Internet. The primary event presentations, may include, but are not limited to programs such as sitcoms, live soccer matches, and reality shows. The primary event presentations may also include various advertisements and commercials, referred to herein generically as ancillary presentations. The advertisements and commercials are primary sources of revenue for a broadcaster. The broadcaster broadcasts the multimedia events that the viewers receive at the viewer's end. The viewers' and the broadcasters' relationship can be referred to as a viewer-server system, wherein the broadcaster serves the multimedia events and the viewers receive these event presentations. In accordance with an embodiment of the present invention, the viewers receive the multimedia events and one or more interactive presentations (games) in the form of graphic rich overlays, again through a broadcasting module from the server end. The one or more interactive presentations that are overlaid on the multimedia event presentations are subject matter related in some way to the multimedia events. The one or more interactive presentations (games) encourage the viewer to actively participate and in turn encourage the viewer to watch the multimedia event presentations (both the primary and the ancillary).

The viewers, while watching the multimedia event presentations, participate in the one or more games and send responses to the server. The server informs the viewers of the accuracy of their responses and awards and accumulates points accordingly. The competition to score more and more points in one or more games encourages the viewers to watch the multimedia event presentations more closely. Those viewers that are awarded points totaling more than a predefined total may be awarded various gifts and prizes by the broadcaster.

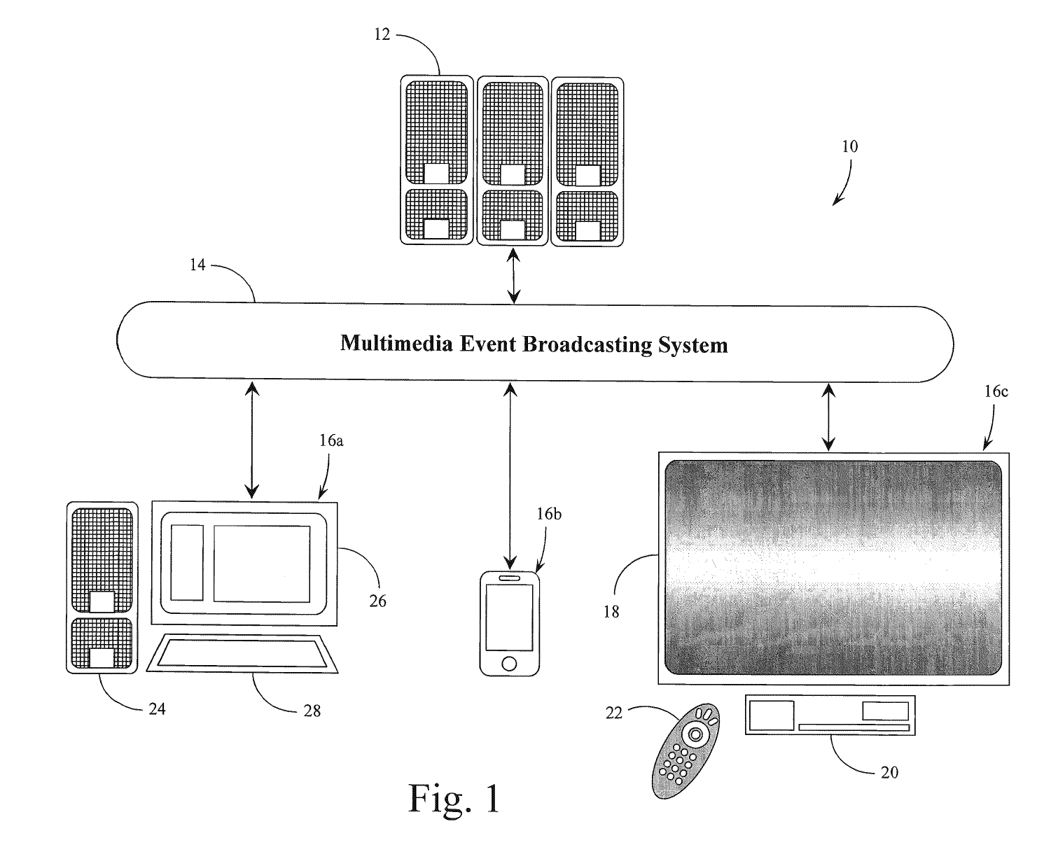

In an embodiment of the present invention, the viewer may be presented with a detailed menu bar as part of the interactive presentation. The detailed menu bar may be presented in part to provide information regarding the multimedia event presentations being broadcast. In another embodiment of the present invention, a chat interface in the form of a graphic rich overlay can also be provided as part of the interactive presentation over the multimedia event presentations. The chat interface allows various viewers to interact with one another while viewing the multimedia event presentations being broadcast. Thus the system of the present invention aims at enhancing the viewers' interactivity with the server and in turn the broadcaster. These and other embodiments of the system and the methods of the present invention will now be discussed in detail with reference to FIGS. 1-4.

FIG. 1 is a schematic block diagram illustrating an environment 10 within which the system and the methods of the present invention can be implemented. Environment 10 includes one or more receiving modules 16a-16c belonging to one or more viewers, and a server 12. Server 12 is connected to the one or more receiving modules 16a-16c by way of a broadcasting system 14. Examples of receiving modules include, but are not limited to, a television 16c, a personal computer 16a, a mobile phone (not shown) with a video receiving capability, or a personal digital assistant (PDA) 16b. The typical television receiving module 16c may preferably include a display 18, a transceiver device 20, and a user input device 22 such as a remote control. In a similar manner, the typical personal computer receiving module 16a may preferably include a central processing unit 24, a display 26, and a user input device 28 such as a keyboard and/or a mouse. PDA receiving module 16b would likewise incorporate analogous electronics including a display and a user keypad or the like.

Several broadcasting systems 14 broadcasting visual events to one or more receiving modules 16a-16c are well known in the art. Examples of broadcasting systems 14 include, but are not limited to, a satellite transmission system, a cable transmission system, a terrestrial television transmission system, an on-demand video transmission system, and a transmission system via the Internet through cable, fiber or DSL. The generic representation of multimedia event broadcasting system 14 shown in FIG. 1 is an indication of the wide variety of such systems that could be implemented in conjunction with the system and the methods of the present invention.

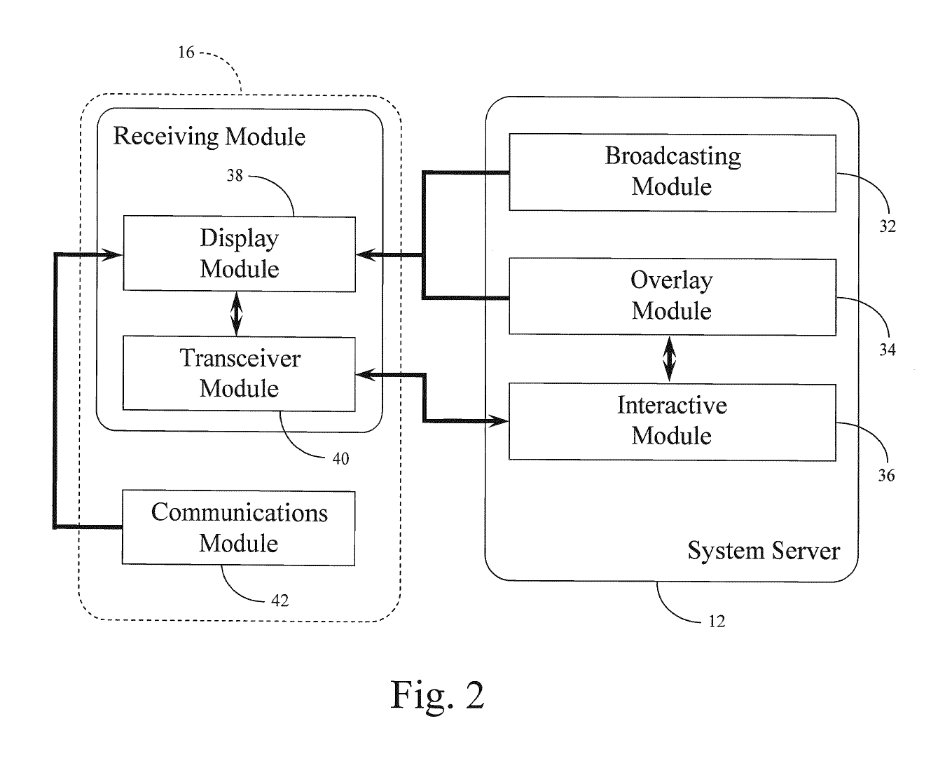

FIG. 2 is a block diagram illustrating in a functional arrangement, the basic system for encouraging viewers to watch multimedia event presentations, in accordance with an embodiment of the present invention. The modules illustrated in FIG. 2 correspond to the modules schematically illustrated in FIG. 1. System server 12 includes a broadcasting module 32, an overlay module 34 and an interactive module 36. Broadcasting module 32 contains various multimedia event presentations that can be broadcast to one or more receiving modules 16 belonging to the one or more viewers over broadcast systems of the various types mentioned above. These multimedia event presentations may be live events or non-live events, i.e., recorded events. Examples of such multimedia event presentations include, but are not limited to, a live soccer game, a sitcom, a movie, an audio-video commercial, and news programming.

Overlay module 34 within system server 12 broadcasts various types of interactive presentations (games) in the form of graphic rich overlay over the multimedia event presentations. Examples of the one or more games may include, but are not limited to, movie quizzes, match predictions, and questions related to the events displayed in the multimedia event presentations. The one or more games contained in overlay module 34 are preferably constantly updated, and new games are provided by the broadcaster for arousing the interest of the viewer.

Interactive module 36 receives the viewers' responses for the interactive presentations overlaid on the multimedia event presentations, and checks the accuracy of the responses. According to the accuracy of the responses, interactive module 36 informs the viewers and awards points to the viewers. If the number of correct responses from a viewer exceeds a predefined number of responses, interactive module 36 informs those viewers as to their receipt of an award or gift.

Each of the one or more receiving modules 16 comprises a display module 38, a transceiver module 40, and a communications module 42. Display module 38 displays the multimedia event presentations and the one or more interactive presentations (games) in the form of graphic rich overlays. Transceiver module 40 communicates with interactive module 36. Communications module 42 is used by the viewers for accessing and responding in the one or more interactive presentations provided over the multimedia event presentations. It will be apparent to a person skilled in the art that a display module 38 includes the screen of the one or more receiving module 16, for example; in case of a television the display module includes the television screen. Examples of communications module 42 include, but are not limited to, a mouse, a television remote control, a mobile phone keypad, a joystick, a trackball and a keyboard. Examples of a transceiver module 40 include, but are not limited to, a set top box, a LAN (local area network) card, and other types of analog or digital transmitters and receivers.

Although many receiving modules 16, such as televisions, were initially “one-way” communications devices (i.e. they were receivers only), most such systems have now integrated two way communications as part of their broadcast configuration. In some instances, such as with personal computers and PDA devices, this two way communication is inherent in the system. In other instances, this two way communication is established using a combination of the primary medium (broadcast TV for example) and a secondary medium such as a telecommunications (phone) system network. Two way communications is now commonplace on cable TV networks and satellite TV networks commonly make use of telephone networks for two way communication. In general therefore, there are no technical barriers to the implementation of the system and the methods of the present invention related to establishing this two way communication between the server and the viewer.

In one embodiment of the present invention, the multimedia event presentations are broadcast by streaming the audio/video events over the Internet. The streamed events can be viewed by the viewers on any of the video viewing applications associated with a personal computer. Examples of computer based video viewing applications include, but are not limited to, media players, flash players, and audio/video players. In some cases the video viewing applications are embedded on social networking sites such as Facebook® (www.facebook.com) and Orkut® (www.orkut.com).

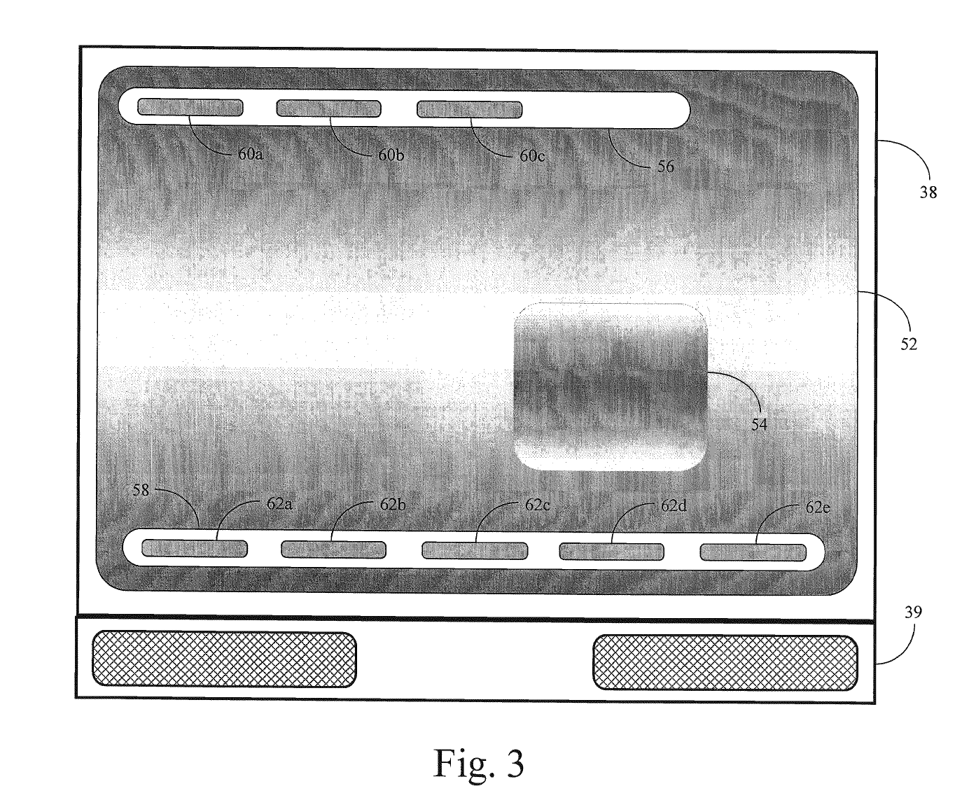

Reference is now made to FIG. 3 which illustrates a display module 38 in accordance with an embodiment of the present invention. The video viewing application 52 is displayed on the display module 38. The multimedia event presentations are viewed by the viewers on the video viewing application 52. Also shown in FIG. 3 are the audio speaker components 39 that provide the associated sounds of the multimedia event presentations and are analogous to the display module 38 which provides the visual elements of the presentations.

The multimedia event presentations shown on video viewing application 52 are overlaid by one or more interactive presentations in form of graphic rich overlays 54. A detailed menu bar can also be overlaid over the event presentations as indicated by 56 and 58. Detailed menu bars 56 and 58 have tabs 60a-60c and 62a-62e respectively. The broadcasters may provide various content in tabs 60a-60c and 62a-62e. For example; selecting tab 60a may result in the opening of a list containing various types of event presentations that are available for viewing. Selecting tab 60b may result in the opening of a list containing the event presentations that a viewer might have stored earlier. Selecting tab 60c may result in the opening of a list containing features to adjust visual settings of the video viewing application 52.

Selecting tab 62a may result in the opening of a list of characters involved in the ongoing multimedia event presentation on the video viewing application 52. For example, if the ongoing event is a live basketball match then selecting tab 62a may result in the opening of a list displaying the names of the players involved in the basketball match. Selecting tab 62b may result in the opening of a list containing details of the every character involved in the ongoing event presentation, for instance if the ongoing event is a live basketball match then selecting tab 62b may result in the opening of a list containing players name and selecting (moving a cursor and selecting) any of the names results in a graphic rich overlay displaying statistics for that player. Selecting tab 62c may result in opening a chat interface in the form of a graphic rich overlay. Selecting tab 62d may result in a graphic rich overlay displaying the points scored by the viewer in the one or more interactive presentations (games) 54 overlaid over the multimedia event presentation. Tab 62e may be used to display any other kind of trivial information related to the ongoing multimedia event presentation.

The number of tabs that are provided on the video viewing application 52 is not limited to the above examples and can be increased and/or decreased pursuant to the information and control provided by the broadcaster. The viewer participates in the one or more interactive presentations 54 by using the communication module (see 42 in FIG. 2) and similarly may chat with other viewers by using the communication module (42 in FIG. 2). In this way the present invention enables viewers to actively interact with the broadcaster as well as with one or more other viewers.

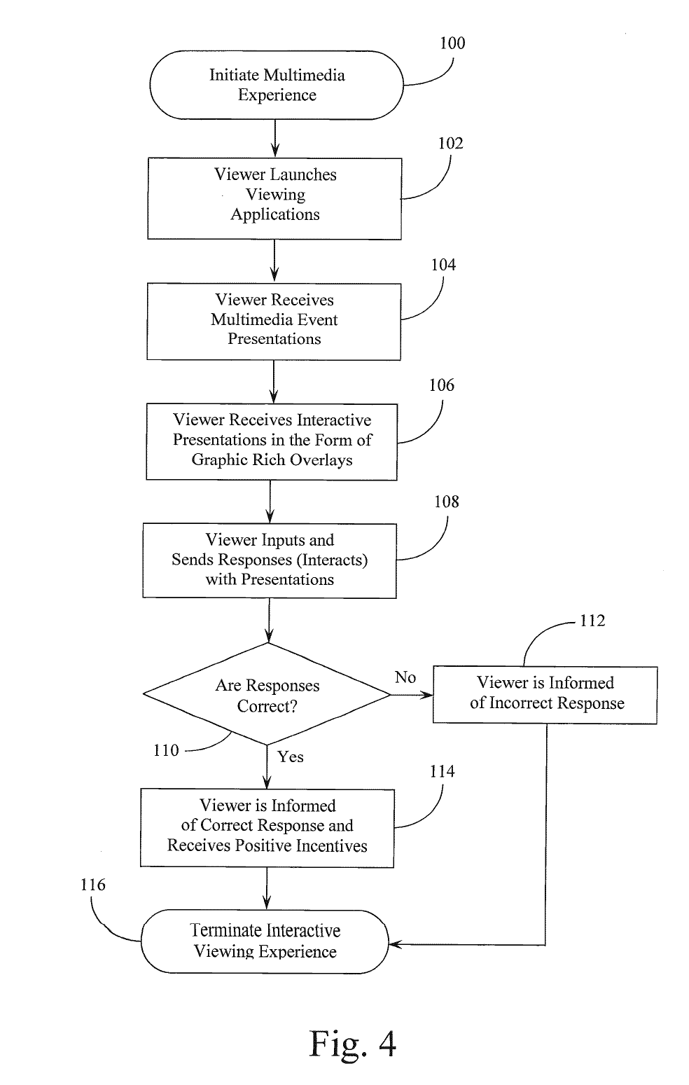

FIG. 4 is a flow chart illustrating a method for encouraging viewers to watch multimedia event presentations in accordance with an embodiment of the present invention. FIG. 4 discloses a high level overview of the basic interaction component of the system and methods of the present invention. The elements or steps in the method are intentionally generic in their description to the extent that they are intended to cover a variety of different interactions involved in a variety of games and activities. The method steps shown focus on the interactive steps involved in the process since, as indicated above, the basic technology and the procedures associated with the transmission and reception of various visual and audible events and selections are generally known. It is in the manner in which these are combined into the interactive presentation and the manner in which they function to engage the viewer when they might otherwise be distracted that is unique.

In the following description of the method steps in FIG. 4, the various hardware components referred to may best be referenced in conjunction with FIG. 2. Therefore, while the method steps will be described in FIG. 4, the system component references refer back to FIG. 2. In FIG. 4 the viewing experience routine 100 is initiated at Step 102, wherein a viewer, having one or more receiving modules 16, launches the video viewing application 52 (in FIG. 3) on the display module 38. At Step 104, the receiving module receives the multimedia event presentations from system server 12. The multimedia event presentations (both the primary (show) and the ancillary (commercial) presentations are broadcasted by the broadcasting module 32 through broadcasting system 14 (in FIG. 1). At Step 106, one or more receiving modules receive one or more games 54 (in FIG. 3) in the form of graphic rich overlays from overlay module 34. The received multimedia event presentations and the one or more interactive presentations (games) 54 are displayed on display module 38. At Step 108 the viewer, while viewing the multimedia event presentations, is able to participate in the one or more games and to respond by way of the communication module 42. The viewer's responses are then received by interactive module 36 in the system server 12.

In an embodiment of the present invention, the one or more interactive presentations (games) which are displayed on display module in the video viewing application 52 are related to ongoing multimedia event presentation. For example, if the ongoing multimedia event presentation is a commercial promoting a certain type of car, the one or more games in the form of graphic rich overlay may be a question regarding the car's horse power. The viewer may be provided with a number of choice options which include one correct option as the actual horse power of the car. The viewer who chooses the correct option is rewarded with points. In addition to providing one or more games 54 (in FIG. 3) to the viewer, detailed menu bars 56 and 58 (in FIG. 3) related to the ongoing multimedia event presentation can also be provided in form of graphic rich overlays, in accordance with an embodiment of the present invention. For example; a viewer watching a live sports event can be provided with a menu bar containing player statistics, team statistics, different camera angles and the like. In a similar manner, viewers can also be provided with a chat interface in form of graphic rich overlays.

Referring again to FIG. 4, at Step 110, the interactive module 36 evaluates the viewer's response and informs the viewer about the correctness of the response at either Step 112 (incorrect) or at Step 114 (correct). If the viewer responses are judged correct by interactive module 36, various incentives and/or rewards may be provided to the viewer at Step 114. In accordance with one embodiment of the present invention the incentives comprise awarding points to the viewer. On the accumulation of a certain total of points the viewer may be rewarded with some material gift, gift vouchers, discount vouchers and the like. The interactive viewing experience is then terminated at Step 116.

The present invention thus provides a platform that allows broadcasters to promote visual events and encourage viewers to watch commercials as well. The present invention provides the viewers a unique perspective of viewing the multimedia event presentations wherein along with viewing the presented events the viewers can actively participate in the one or more interactive presentations or games, all the while remaining engaged with the commercial content. In this manner watching multimedia event presentations becomes a whole new interactive session for the viewers.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims that follow.

I claim:

1. A method for encouraging viewers to remain engaged with one or more broadcast multimedia event presentations, the method comprising the steps of:
(a) broadcasting the one or more multimedia event presentations to the viewers;
(b) providing one or more interactive presentations in the form of graphic rich overlays over the broadcast multimedia event presentations; and
(c) providing incentives to the viewers according to their performance in the one or more interactive presentations, their performance indicative of a level of engagement with the broadcast multimedia presentations.

2. The method of claim 1 wherein the one or more multimedia event presentations are at least one of; a live event, a non-live events, and a commercial.

3. The method of claim 1 wherein the one or more multimedia event presentations are broadcast through at least one of; a satellite transmission system, a cable transmission system, an Internet Protocol, and an Internet streaming system.

4. The method of claim 1, wherein the broadcast one or more multimedia event presentations are received by the viewers on a display device.

5. The method of claim 4, wherein the display device is one of; a television, a personal computer, a video-capable mobile telephone, and a personal digital assistant.

6. The method of claim 1, wherein the step of providing incentives comprises awarding points on the basis of a viewer's performance in the one or more interactive presentation.

7. The method of claim 6, wherein the viewers may be awarded with one or more of; gifts, discount vouchers, and gift vouchers on the basis of aggregate points accumulated.

8. The method of claim 1, further comprising the step of providing the viewers a detailed menu bar in the form of graphic rich overlays over the one or more multimedia event presentations.

9. The method of claim 1, further comprising the step of providing the viewers a chat interface in the form of graphic rich overlays over the one or more multimedia event presentations.

10. A method for encouraging viewers to remain engaged with one or more broadcast commercials, the method comprising the steps of:
(a) broadcasting the one or more commercials to the viewers;
(b) providing one or more games in the form of graphic rich overlays over the broadcast commercials; and
(c) providing incentives to the viewers according to their performance in the one or more games.

11. A system for encouraging viewers to remain engaged with one or more broadcast multimedia event presentations, the system comprising:
(a) a server module, the server module comprising:
(i) a broadcasting module containing the one or more multimedia event presentations;
(ii) an overlay module for providing one or more interactive presentations in the form of graphic rich overlays over the one or more multimedia event presentations; and
(iii) an interactive module for receiving viewer actions in the one or more interactive presentation and providing incentives to the viewers;
(b) a receiving module, the receiving module comprising:
(i) a display module for displaying the broadcast multimedia event presentations;
(ii) a communications module for allowing viewer interaction in the one or more interactive presentations provided over the multimedia event presentations; and
(iii) a transceiver module for communicating with the communications module and receiving the viewer responses and for providing incentives.

12. The system of claim 11 wherein the multimedia event presentations contained in the broadcasting module are broadcast to the receiving module through at least one of; satellite transmission, cable transmission, Internet protocol, and Internet streaming.

13. The system of claim 11 wherein the display module comprises at least one of; a television, a personal computer, a video-capable mobile phone, and a personal digital assistant.

14. The system of claim 11 wherein the communications module comprises at least one of a television remote control, a mouse, a trackball, a mobile phone keypad, a keyboard, and a video game controller.
